(19) United States
(12) Patent Application Publication
(10) Pub. No.: US 2023/0318250 A1
(43) Pub. Date: Oct. 5, 2023

(54) MULTICORE MASTER OSCILLATOR POWER AMPLIFIER

(71) Applicant: Lumentum Operations LLC, San Jose, CA (US)

(72) Inventors: Richard D. FAULHABER, San Carlos, CA (US); Martin H. MUENDEL, Oakland, CA (US); Patrick GREGG, Sunnyvale, CA (US); Ning LIU, Morgan Hill, CA (US)

(21) Appl. No.: 17/809,417

(22) Filed: Jun. 28, 2022

Related U.S. Application Data
(60) Provisional application No. 63/362,277, filed on Mar. 31, 2022.

(51) Int. Cl. H01S 3/094; H01S 3/067; H01S 3/10; H01S 3/0941

(52) U.S. Cl. CPC H01S 3/094007; H01S 3/0675; H01S 3/10023; H01S 3/09415; H01S 3/06733

(57) ABSTRACT

In some implementations, a master oscillator power amplifier (MOPA) system may include one or more pump laser sources, a power amplifier, and a multicore oscillator that includes an input side coupled to the one or more pump laser sources and an output side coupled to the power amplifier. In some implementations, the multicore oscillator may include an active fiber, including an inner cladding, an outer cladding surrounding the inner cladding, and multiple active fiber cores, embedded in the inner cladding, to convert pump light into signal light. In some implementations, the multicore oscillator may include multiple first reflectors that are each configured to operate as a high reflector on the input side of the oscillator, and multiple second reflectors that are each configured to operate as an output coupler on the output side of the oscillator.

### CROSS-REFERENCE TO RELATED APPLICATION

This Patent Application claims priority to U.S. Provisional Patent Application No. 63/362,277, filed on Mar. 31, 2022, and entitled “MULTICORE MASTER OSCILLATOR POWER AMPLIFIER.” The disclosure of the prior Application is considered part of and is incorporated by reference into this Patent Application.

### TECHNICAL FIELD

The present disclosure relates generally to a master oscillator power amplifier (MOPA) laser architecture and to a multicore oscillator that may be used in a MOPA architecture to increase pump-to-signal conversion, reduce stimulated Raman scattering (SRS) gain, reduce photo darkening, and/or maintain stability at an output from the multicore oscillator.

### BACKGROUND

Laser power scaling includes techniques to increase an output power from a laser without changing the geometry, shape, or principle of operation of the laser. Power scalability, which is generally considered an important advantage in laser design, usually requires a more powerful pump source, stronger cooling, an increase in size, and/or a reduction in background loss in a laser resonator and/or a gain medium. For example, one approach to achieve power scalability is to use a master oscillator power amplifier (MOPA) architecture. For example, in a MOPA system, the master oscillator produces a highly coherent beam, and an optical amplifier is used to increase the power of the beam while preserving the main properties of the beam.

### SUMMARY

In some implementations, a multicore oscillator comprises an active fiber that includes: an inner cladding; an outer cladding surrounding the inner cladding; and multiple single mode active fiber cores, embedded in the inner cladding, to convert pump light into signal light; multiple first fiber Bragg gratings (FBGs) that are each configured to operate as a high reflector (HR) on an input side of each of the active fiber cores; and multiple second FBGs that are each configured to operate as an output coupler (OC) on an output side of each of the active fiber cores.

In some implementations, a master oscillator power amplifier (MOPA) system includes: one or more pump laser sources; a power amplifier; and an oscillator including an input side coupled to the one or more pump laser sources and an output side coupled to the power amplifier, wherein the oscillator includes: an active fiber including: an inner cladding; an outer cladding surrounding the inner cladding; and multiple active fiber cores, embedded in the inner cladding, to convert pump light into signal light; multiple first reflectors associated with each of the active fiber cores that are each configured to operate as an HR on the input side of the oscillator; and multiple second reflectors associated with each of the active fiber cores that are each configured to operate as an OC on the output side of the oscillator.

In some implementations, a method includes providing an input light by a pump laser source that includes one or more pump laser diodes; converting the input light into signal light by an oscillator that includes an input side coupled to the pump laser source, wherein the oscillator includes: an active fiber including: an inner cladding; an outer cladding surrounding the inner cladding; and multiple single mode active fiber cores, embedded in the inner cladding, to convert the input light into the signal light; and amplifying the signal light by a power amplifier coupled to an output side of the oscillator.

### BRIEF DESCRIPTION OF THE DRAWINGS

FIGS. 1A-1B are diagrams illustrating examples of a master oscillator power amplifier (MOPA) laser architecture.

FIGS. 2A-2B are diagrams illustrating one or more examples of a MOPA laser architecture that includes a multicore oscillator.

FIGS. 3A-3B are diagrams illustrating example cross-sections of a multicore active fiber that may be used in a MOPA laser architecture with a multicore oscillator.

FIGS. 4A-4C are diagrams illustrating example interfaces to couple a multicore oscillator and a power amplifier in a MOPA laser architecture.

FIG. 5 is a diagram illustrating an example process for operating a MOPA laser system that includes a multicore oscillator.

### DETAILED DESCRIPTION

The following detailed description of example implementations refers to the accompanying drawings. The same reference numbers in different drawings may identify the same or similar elements.

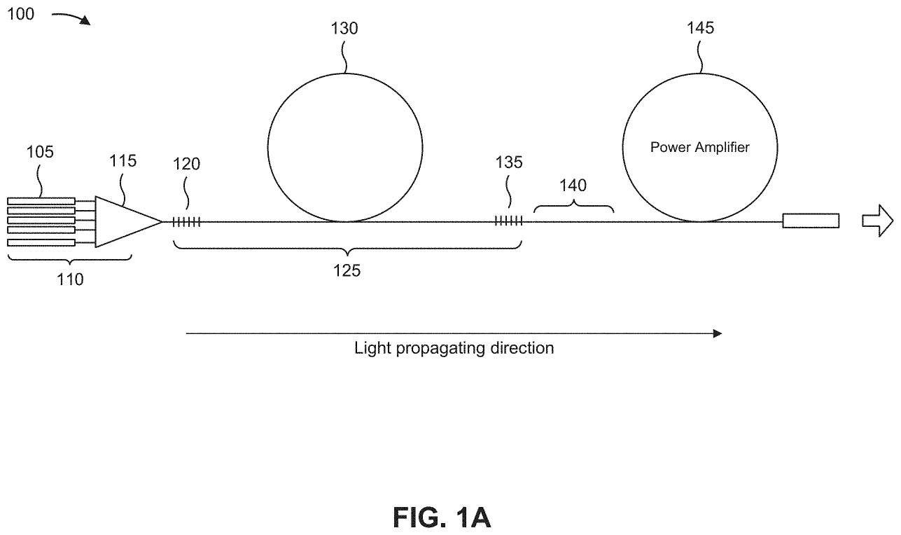

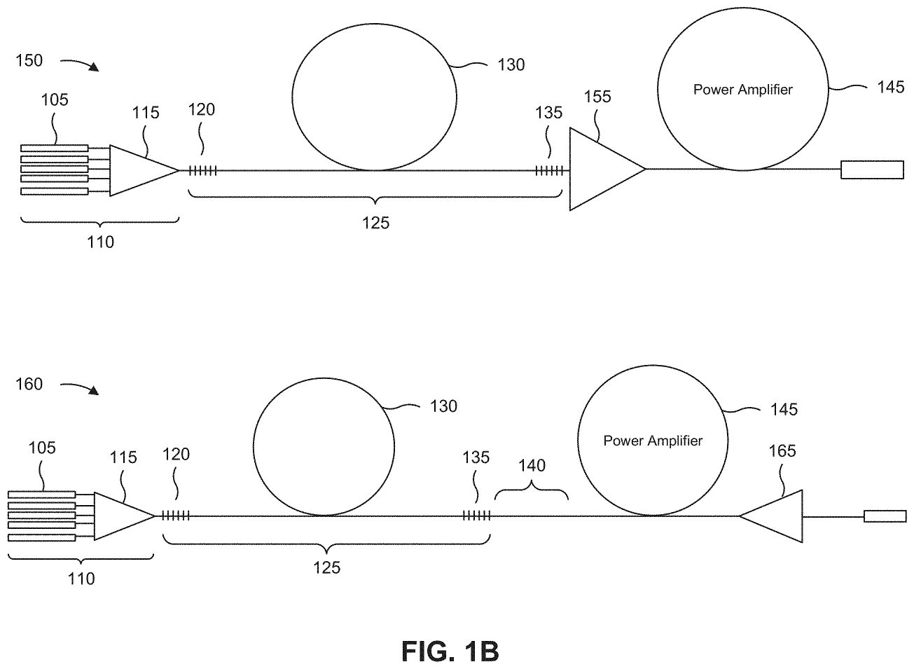

A master oscillator power amplifier (MOPA) architecture is a laser configuration in which a seed laser is used to generate a beam, and an optical amplifier is used to boost the output power of the beam. For example, in a MOPA architecture, the output from a low-power, single-frequency laser oscillator may be injected unidirectionally into an optical amplifier with greater output power capacity. A special case is a master oscillator fiber amplifier (MOFA), where the power amplifier is a fiber device. In other cases, a MOPA may include a solid-state bulk laser and a bulk amplifier, or a tunable external cavity diode laser and a semiconductor optical amplifier. For example, FIG. 1A illustrates an example 100 of a MOPA laser architecture that includes a multi-kilowatt (kW) pump source 110 comprised of a set of laser diodes 105, a combiner 115, and a set of output fibers coupling the set of laser diodes 105 and the combiner 115. As further shown, the MOPA laser architecture may include a first reflector 120 (e.g., a first fiber Bragg grating (FBG)) used as a high reflector (HR) (that reflects a high percentage of the light emitted from the active fiber 130) between the combiner 115 and an input end of an active fiber 130. As further shown in FIG. 1A, the MOPA laser architecture may include a second reflector 135 (e.g., a second FBG) used as an output coupler (OC) at an output end of the active fiber 130. The first reflector 120, the active fiber 130, and the second reflector 135 comprise the oscillator 125 of the MOPA 100. The MOPA laser architecture may further include a power amplifier 145, and a passive fiber 140 coupling the output end of the oscillator 125 to the power amplifier 145 (e.g., via the second reflector 135 configured as the OC at the output end of the active fiber 130), as well as various other components in the optical chain (e.g., filters for undesired wavelengths or unabsorbed pump) and/or the like.

Although a MOPA configuration may be more complex than a laser that can directly produce the required output power, a MOPA configuration may achieve a required performance more easily (e.g., in terms of linewidth, wavelength tuning range, beam quality, or pulse duration) in cases where the required output power is high. In addition, a MOPA configuration may be used to modulate a low-power seed laser or may use an optical modulator between the seed laser (e.g., the oscillator 125) and the power amplifier 145 rather than modulating a high-power device directly, may use an existing laser and an existing amplifier (or amplifier chain) and thereby obviate a need to develop a new laser with a higher output power, and/or may use an amplifier that has lower optical intensities compared with the intracavity intensities in a laser.

However, power scaling a MOPA laser architecture to higher and higher powers is challenging. For example, the oscillator 125 in a MOPA laser architecture should be maintained as near to single mode as possible for stability, which is challenging because converting pump light to signal light in the oscillator 125 is limited by stimulated Raman scattering (SRS) or other nonlinear effects when power scaling. In particular, SRS is a nonlinear optical effect where energy from an optical beam is converted to a longer wavelength via vibrational and/or rotational modes or phonons being excited in the molecules of a glass medium. While this process may be useful for certain applications (e.g., to turn an optical fiber into a Raman amplifier or a tunable Raman laser), SRS is undesirable for multi-kW continuous wave (CW) industrial fiber lasers or quasi-CW kW fiber lasers used in the cutting and welding industries. For example, in industrial applications, SRS may transfer energy from one wavelength to another wavelength and/or limit the power that can propagate without unwanted loss and/or heating, which may negatively impact the industrial processes and/or cause damage to equipment. As power levels for industrial kW fiber lasers continue to increase, SRS becomes more problematic, and a need arises for techniques to suppress SRS.

Furthermore, simply increasing the pump power on the input end of the oscillator 125 would also increase the signal power on the output end of the oscillator 125, which can be problematic. Other potential solutions to the power scaling problem in a MOPA laser architecture are also sub-optimal. For example, another potential approach may be to reduce absorption in the oscillator either by decreasing doping or shortening the length of the active fiber 130. Other potential approaches may include adding new pumping schemes with one or more additional laser diodes after the oscillator. For example, FIG. 1B illustrates an example 150 of a cascade pump architecture where one or more additional laser diodes and/or oscillators (not shown) feeding into a combiner 155 are arranged between the second reflector 135 and the power amplifier 145, and an example 160 of a counter pump architecture where one or more additional laser diodes or oscillators (not shown) feeding into a combiner 165 are arranged in a counter-propagating direction after the power amplifier 145. However, these approaches all suffer from one or more drawbacks, such as introducing additional components (e.g., the additional laser diodes/oscillators and combiners 155 and/or 165), increasing structural complexity, and/or increasing the number of splices.

Some implementations described herein relate to a multicore master oscillator (which may be referred to herein as a multicore oscillator for brevity) that may be used to improve power scaling performance in a MOPA architecture (e.g., where the multicore oscillator launches into a power amplifier with a larger core). For example, as described above, the master oscillator in a MOPA laser architecture is most stable when operating in a regime that is single mode or near single mode. Otherwise, transverse modal instabilities can arise when oscillator dimensions are not well-controlled. Furthermore, FBGs and/or other devices that are used as HR and/or OC reflectors are generally easier to write and/or measure when the reflector devices are single mode or near single mode. Accordingly, in some implementations, the multicore oscillator described herein may include multiple independent single mode or near single mode (e.g., within a threshold of single mode) master oscillators that are fabricated within one fiber, which increases pump-to-signal conversion, reduces SRS gain, reduces photo darkening, and maintains stability coming out of the multicore oscillator. In this way, a signal power from the multicore oscillator may be increased, which reduces inversion and/or heating in the subsequent amplifier stage(s).

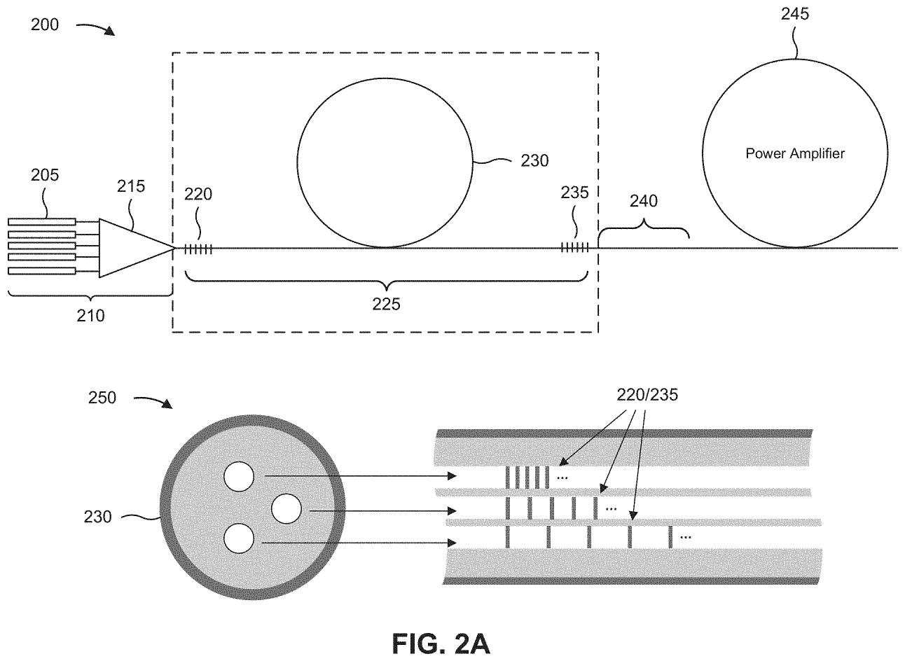

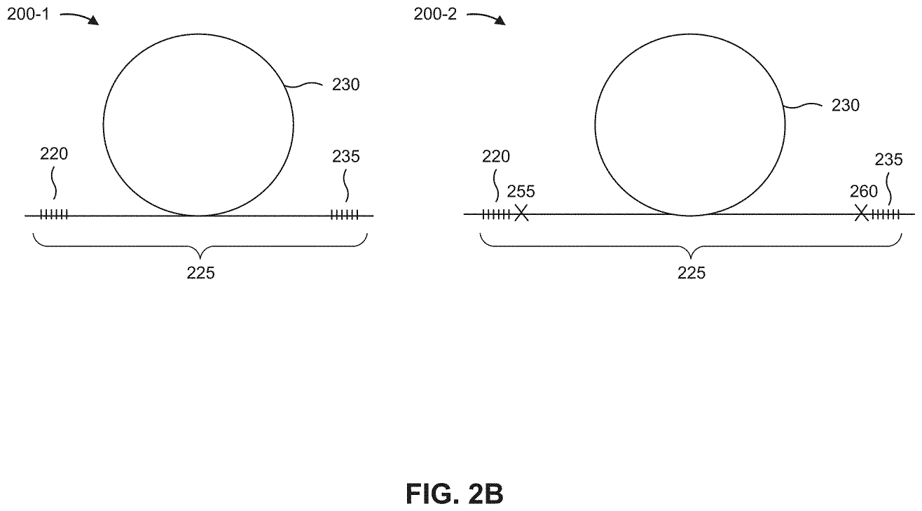

FIGS. 2A-2B are diagrams illustrating one or more examples 200 of a MOPA laser architecture that includes a multicore oscillator 225 coupled to a power amplifier 245. For example, as shown in FIG. 2A, the MOPA laser architecture may include a multi-kilowatt (kW) pump source 210 comprised of a plurality of laser diodes 205 and a combiner 215. The multi-kW pump source 210 may define a pump laser source configured to generate input light to the MOPA laser architecture. As further shown, the MOPA laser architecture may include a plurality of HR reflectors 220 (e.g., a plurality of first FBGs—for clarity, only a single reflector 220 is shown in the upper part of FIG. 2A) provided at an input end of a multicore active fiber 230 (e.g., at an interface between the combiner 215 and the multicore active fiber 230), or a passive multicore fiber matched to the multicore active fiber 230. Each of the plurality of HR reflectors 220 is associated with one core of the multicore active fiber 230. As further shown, a plurality of OC reflectors 235 (e.g., a plurality of second FBGs—for clarity, only a single OC reflector 235 is shown in the upper part of FIG. 2A) may be provided at an output end of the multicore active fiber 230 (e.g., at an interface between the output end of the multicore active fiber 230 and a passive fiber 240 coupling into the power amplifier 245). Each of the plurality of OC reflectors 235 may be associated with one core of the multicore active fiber 230. Further, an FBG reflector associated with one core of the multicore active fiber 230 is associated with the corresponding OC reflector of the same core of the multicore active fiber 230. Further, the MOPA laser architecture may include a multicore oscillator 225 which may include the plurality of HR reflectors 220, the plurality of OC reflectors 235, and the multicore active fiber 230. Each oscillator of the multicore oscillator 225 may include one of the plurality of HR reflectors 220, one core of the multicore active fiber 230, and one of the plurality of OC reflectors 235. The input light may be converted into signal light by the multicore oscillator 225, and the signal light may then be amplified to a higher power level by the power amplifier 245. For example, in FIG. 2A, reference number 250 depicts a configuration in which the multicore active fiber 230 includes multiple cores (e.g., three in the illustrated example), with reflectors 220/235 written into the different cores of the multicore oscillator 225. In the example shown in FIG. 2A, the periods of the reflectors 220/235 are different from one another, where varying the periods of the reflectors 220/235 allows different wavelengths to oscillate in each oscillator (e.g., in each core of the multicore oscillator 225). Alternatively, in some implementations, the periods of the reflectors 220/235 may match one another to allow a specific wavelength to oscillate in each oscillator, or one of the reflectors 220/235 may be a narrow grating that overlaps with a broader grating, as described in more detail below. Alternatively, in some implementations, a single grating 220/235 may be written across the entire fiber 230 using a femtosecond laser or the like. In a configuration where a single grating 220/235 is written across the entire fiber 230, the entire fiber 230 may be exposed at once to write the same grating 220/235 across all cores. In any case, by providing the multicore oscillator 225 with multiple independent cores, pump-to-signal conversion may be effectively multiplied without significantly increasing SRS or other nonlinear effects. For example, a single core in the oscillator 225 may generally generate a given amount of power (e.g., based on conversion of pump power in that core), whereby doubling, tripling, quadrupling, or otherwise multiplying the number of cores in the multicore oscillator 225 that operate independently of each other may effectively multiply the pump-to-signal conversion that occurs within the multicore oscillator 225.

In some implementations, in order to maximize stability, the multicore oscillator 225 may be configured to operate in a single mode regime. For example, as described herein, the multicore oscillator 225 may be configured to be single mode (e.g., designed to reflect only a single mode of light), near single mode (e.g., within a threshold of single mode), a single transverse mode and a single polarization mode, a single transverse mode but not a single polarization mode, or the like. In any case, by operating the multicore oscillator 225 in a single mode regime, the MOPA laser architecture shown in FIG. 2A may avoid transverse modal instabilities that could otherwise arise if the parameters of the multicore active fiber 230 or any other signal-carrying fiber within the multicore oscillator 225 were not well-controlled. Furthermore, fabricating multiple independent single mode or near single mode oscillator cores within one active fiber 230 may simplify techniques used to write and/or measure the FBGs or other reflectors configured to operate as the HR reflector 220 and/or the OC reflector 235. Accordingly, as described herein, the MOPA architecture shown in FIG. 2A includes a multicore oscillator 225 with multiple independent single mode or near single mode master oscillators that may be fabricated within one fiber 230, which increases pump-to-signal conversion, reduces SRS gain, reduces photo darkening, and maintains stability coming out of the multicore oscillator. In this way, a signal power from the multicore oscillator 225 may be increased, which reduces inversion and/or heating in the subsequent stage(s) that include the power amplifier 245. Additionally, or alternatively, more than one mode may be carried in one or more cores of the multicore oscillator 225. For example, in some implementations, the FBGs or other reflectors configured to operate as the HR reflector 220 and/or the OC reflector 235 may be used to achieve single mode lasing in a multimode fiber, because the higher order modes would have different resonance wavelengths (e.g., starting with a slightly multimoded fiber, the FBG(s) could be used to give near single mode performance, which may ease manufacturing tolerances).

In some implementations (e.g., as shown by reference number 250), the independent active fiber cores that are included within the multicore oscillator 225 can have different HR reflectors 220 and/or OC reflectors 235 that are fabricated to reflect different wavelengths prior to launching into the power amplifier 245 (e.g., each core of the active fiber 230 may have a pair of FBGs or other devices that are fabricated for a specific wavelength and used as the HR reflector 220 and the OC reflector 235 for a corresponding core, whereby each oscillator may function as an independent laser with different wavelength(s) within the multicore oscillator 225 that includes the multicore active fiber 230). Additionally, or alternatively, rather than fabricating both the HR reflector 220 and the OC reflector 235 for a specific wavelength, only one (e.g., the HR reflector 220) may be fabricated for each wavelength while the other reflector (e.g., the OC reflector 235) may be a wide-bandwidth grating. In this way, undesirable coherence effects may be suppressed when transitioning to the stages associated with the power amplifier 245, which may be addressed by having a length of passive fiber 240 between the multicore oscillator 230 and the power amplifier 245. In some implementations, brightness between the multicore oscillator 225 and the large core power amplifier 245 can be increased by adding a mode-matched passive fiber 240 (e.g., a quarter-pitch graded index fiber or an equivalent step index fiber). In some implementations, the multicore oscillator 225 can also be used with different pump wavelengths within the same pump combiner 215 to enable more efficient conversion within the oscillator cores and later amplifier stage(s).

Referring to FIG. 2B, reference number 200-1 illustrates a first configuration for the multicore oscillator 225, in which the multicore oscillator 225 is comprised of a multicore active fiber 230 that has a plurality of gratings (HR and OC gratings) fabricated directly into the independent active cores of the multicore active fiber 230. For clarity, only one of the plurality of HR 220 and OC 235 gratings are shown in FIG. 2B, and reference number 250 in FIG. 2A illustrates the contemplated configuration in which there are a plurality of gratings written into a respective plurality of cores. In this case, the single active fiber 230 includes multiple doped cores that, in cooperation with the associated FBGs 220/235, act as independent oscillators and are separated from each other to satisfy a threshold level of crosstalk. For example, in some implementations, the multiple doped cores may be separated from each other to avoid or suppress crosstalk between the cores or to minimize a level of crosstalk between the cores. Alternatively, in some implementations, the separation between the cores may be reduced to enable a threshold level of crosstalk between the cores (e.g., in applications where crosstalk is desired, such as coherent beam combining, in which case the separation between the cores may be controlled to achieve a fixed phase relationship between the cores). As shown by reference number 200-1, one or more FBGs used as the HR reflector 220 at the input end of the multicore oscillator 225 and/or one or more FBGs used as the OC reflector 235 at the output end of the multicore oscillator 225 may be written directly into each core on both sides of the active fiber 230 with a femtosecond (FS) laser or other means. For example, in some implementations, a first FBG on the input side of the active fiber 230 may be configured to operate as the HR reflector 220 (e.g., with a reflectivity around 99%) and a second FBG on the output side of the active fiber 230 may be configured to operate as the OC reflector 235 (e.g., with a reflectivity around 10-20%). Alternatively, referring to FIG. 2B, reference number 200-2 illustrates another example configuration in which the multicore oscillator 225 includes matched active and passive fibers. Matched active and passive fibers may have the same number of cores, the same relative positioning of cores within the fibers and/or similar mode sizes and numerical apertures. Matched active and passive fibers may be oriented so that respective cores in the fibers align when the fibers are spliced together or otherwise coupled. In this case, matched multicore passive fibers with the HR reflector 220 and the OC reflector 235 (e.g., respective FBGs) written in each core may be spliced to both ends of a matched multicore active fiber 230. For example, reference numbers 255 and 260 depict respective splices where the matched multicore passive fibers are spliced to both ends of the matched multicore active fiber 230. Furthermore, in a similar manner as the configuration depicted by reference number 200-1, a first FBG on the input side of the active fiber 230 acts as the HR reflector 220 and a second FBG on the output side of the active fiber 230 acts as the OC reflector 235.

As indicated above, FIGS. 2A-2B are provided as examples. Other examples may differ from what is described with regard to FIGS. 2A-2B. The number and arrangement of devices shown in FIGS. 2A-2B are provided as examples. In practice, there may be additional devices, fewer devices, different devices, or differently arranged devices than those shown in FIGS. 2A-2B. Furthermore, two or more devices shown in FIGS. 2A-2B may be implemented within a single device, or a single device shown in FIGS. 2A-2B may be implemented as multiple, distributed devices. Additionally, or alternatively, a set of devices (e.g., one or more devices) shown in FIGS. 2A-2B may perform one or more functions described as being performed by another set of devices shown in FIGS. 2A-2B.

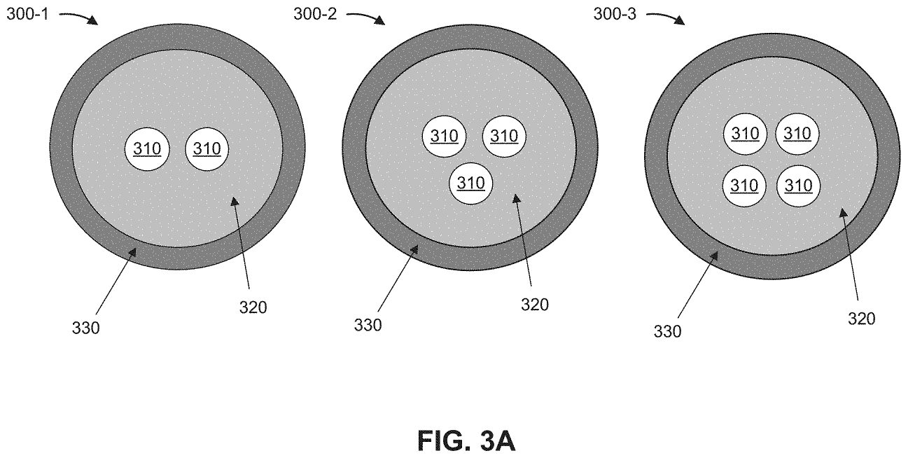

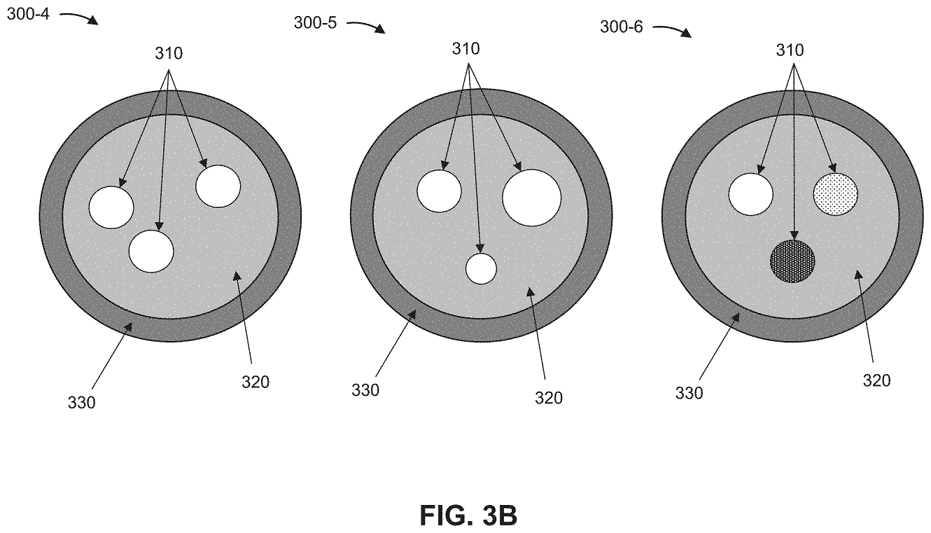

FIGS. 3A-3B are diagrams illustrating example cross-sections 300-1 through 300-6 of a multicore active fiber that may be used in a MOPA laser architecture (e.g., in the multicore oscillator 225 shown in FIGS. 2A-2B). For example, as shown in FIGS. 3A-3B, the multicore active fiber may generally include an inner cladding 320, an outer cladding 330 surrounding the inner cladding 320, and multiple single mode fiber cores 310 that are embedded in the inner cladding and used to convert pump light from a pump laser source into signal light that is launched into a power amplifier. Referring to FIG. 3A, cross-sections 300-1, 300-2, and 300-3 depict example configurations where the multicore active fiber includes two, three, or four identical cores 310 (e.g., the cores 310 have a uniform doping and a uniform core size) with a uniform separation from each other to avoid crosstalk between the cores 310 and/or to satisfy a threshold level of crosstalk between the cores 310. However, it will be appreciated that the multicore active fiber may generally include N cores, where N is an integer greater than one (1).

Additionally, or alternatively, referring to FIG. 3B, cross-sections 300-4, 300-5, and 300-6 depict example configurations where the multicore active fiber includes multiple cores 310 associated with different parameters. For example, as shown by cross-section 300-4, the multicore active fiber may include multiple cores 310 with different core separations (e.g., a first core 310 may be separated from a second core 310 by a first distance and separated from a third core 310 by a second distance that is different from the first distance). Additionally, or alternatively, as shown by cross-section 300-5, the multicore active fiber may include multiple cores 310 with different core sizes (e.g., different core diameters). Additionally, or alternatively, as shown by cross-section 300-6, the multicore active fiber may include multiple cores 310 with a different doping in each core 310 (shown in FIG. 3B by variations in the fill pattern of the different cores 310).

In other examples (not explicitly illustrated), the multiple cores 310 may be twisted around a center axis of the active fiber, which is equivalent to bending of the cores 310 and may ensure that more single mode signal is output by the multicore oscillator. In some implementations, the period of the twisting may be adjusted, which causes the bending diameter to change. Furthermore, in some implementations, twisting the cores 310 may result in a more uniform pump absorption in the different cores 310.

As indicated above, FIGS. 3A-3B are provided as examples. Other examples may differ from what is described with regard to FIGS. 3A-3B. The number and arrangement of devices shown in FIGS. 3A-3B are provided as examples. In practice, there may be additional devices, fewer devices, different devices, or differently arranged devices than those shown in FIGS. 3A-3B. Furthermore, two or more devices shown in FIGS. 3A-3B may be implemented within a single device, or a single device shown in FIGS. 3A-3B may be implemented as multiple, distributed devices. Additionally, or alternatively, a set of devices (e.g., one or more devices) shown in FIGS. 3A-3B may perform one or more functions described as being performed by another set of devices shown in FIGS. 3A-3B.

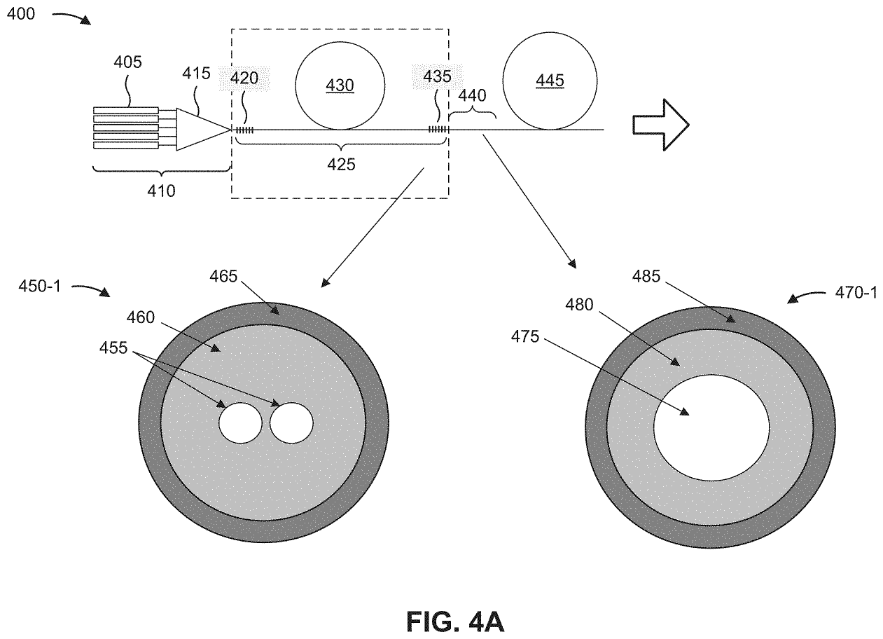

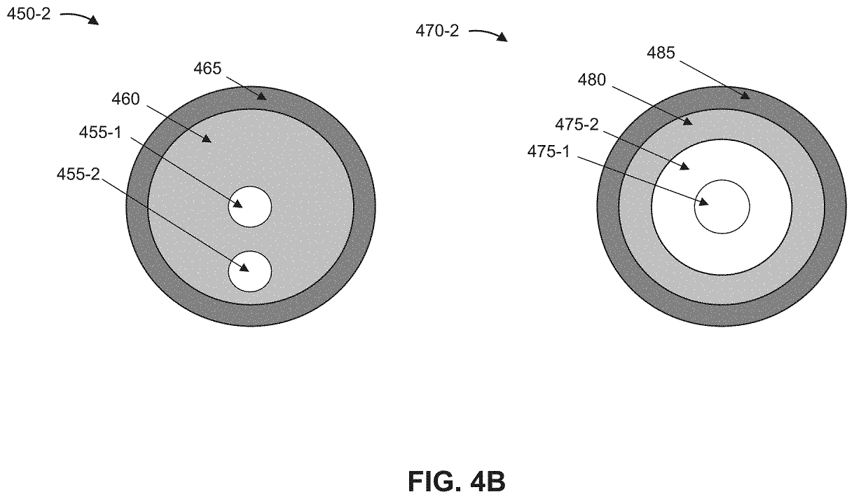

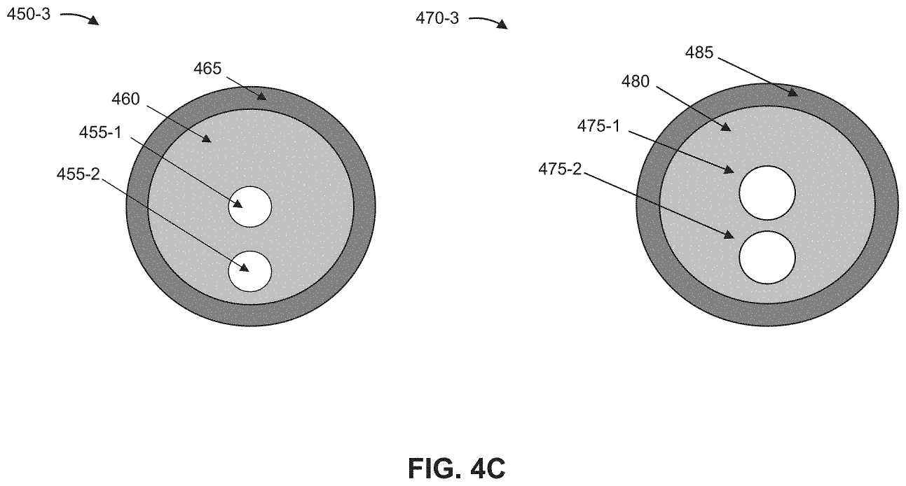

FIGS. 4A-4C are diagrams illustrating an example of a MOPA laser architecture 400 and example interfaces to couple a multicore oscillator 425 and a power amplifier 445 in the MOPA laser architecture. For example, as shown in FIG. 4A, the MOPA laser architecture 400 may include a plurality of laser diodes 405 and a combiner 415 that comprise a multi-kW pump 410 that may define a pump laser source configured to generate input light to the MOPA laser architecture 400. As further shown, the MOPA laser architecture may include a plurality of HR reflectors 420 (e.g., a plurality of first FBGs) provided at an input end of the multicore oscillator 425 (e.g., at an interface between the combiner 415 and an active fiber 430), with one HR reflector 420 provided at the input end of each core of the active fiber 430. As further shown, the MOPA laser architecture 400 may include a plurality of OC reflectors 435 (e.g., a plurality of second FBGs) at an output end of the multicore oscillator 425 (e.g., at an interface between the output end of the active fiber 430 and a passive or active output fiber 440 coupling into the power amplifier 445), with one OC reflector 435 provided at the output end of each core of the active fiber 430.

In some implementations, the power amplifier 445 may be a large mode area (LMA) power amplifier, sometimes referred to as a large core amplifier. In this case, an output from the multicore oscillator 425 may be spliced either to a passive large core bridge output fiber 440 or directly to the large core power amplifier 445. In some implementations, the passive output fiber 440 and/or active core(s) within the output fiber 440 may have dimensions that are chosen to be large enough to fully encircle the multiple cores within the multicore oscillator 425. In some implementations, a quarter-pitch length graded index fiber or other mode-matching fiber can be spliced to the end of the multicore oscillator 425 to better preserve brightness as the light transitions to the large core power amplifier 445. In some implementations, the output fiber 440 may include either a single large core, multiple concentric cores, or multiple offset cores that are matched to the output from the multicore oscillator.

For example, referring to FIG. 4A, reference number 450-1 depicts an example cross-section of the output end of the multicore oscillator 425, which includes two active cores 455 that are embedded in a fused silica inner cladding 460 surrounded by a fluorine (F)-doped outer cladding 465. As further shown, reference number 470-1 depicts an example cross-section of the output fiber 440 spliced to the output of the multicore oscillator 425. As shown, the output fiber 440 is a single core output fiber (e.g., a passive or active output fiber) spliced to the multicore oscillator 425, where the output fiber 440 includes a single large core 475, a fused silica inner cladding 480 surrounding the single large core 475, and an F-doped outer cladding 485 surrounding the fused silica inner cladding 480.

In another example, referring to FIG. 4B, reference number 450-2 depicts an example cross-section in which the multicore oscillator 425 includes a central active core 455-1 and an offset active core 455-2 in a fused silica inner cladding 460 surrounded by an F-doped outer cladding 465. As shown by reference number 470-2, the cross-section of the multicore oscillator 425 is matched to a dual concentric core output fiber (e.g., a passive or active output fiber) that includes an inner core 475-1 matched to the central core 455-1 of the multicore oscillator 425, an outer core 475-2 matched to the offset core 455-2 of the multicore oscillator 425, a fused silica inner cladding 480 surrounding the dual concentric cores 475-1, 475-2, and an F-doped outer cladding 485 surrounding the fused silica inner cladding 480.

In another example, referring to FIG. 4C, reference number 450-3 depicts an example cross-section in which the multicore oscillator 425 has the same configuration as shown in FIG. 4B. As shown by reference number 470-3, the cross-section of the multicore oscillator 425 is matched to a dual offset core output fiber (e.g., a passive or active output fiber) that includes a central core 475-1 matched to the central core 455-1 of the multicore oscillator 425, an offset core 475-2 matched to the offset core 455-2 of the multicore oscillator 425, a fused silica inner cladding 480 surrounding the dual offset cores 475-1, 475-2, and an F-doped outer cladding 485 surrounding the fused silica inner cladding.

In other examples (not explicitly illustrated), the output fiber 440 may have a confined doping, which is similar to a tapered core and may better confine the mode after the signal from the multicore oscillator 425 is launched into the power amplifier 445. Additionally, or alternatively, the oscillator fiber 430 may include a single center offset core that may be twisted, where the mode in the single center offset core can be well-managed by controlling a period of the twisting.

As indicated above, FIGS. 4A-4C are provided as examples. Other examples may differ from what is described with regard to FIGS. 4A-4C. The number and arrangement of devices shown in FIGS. 4A-4C are provided as examples. In practice, there may be additional devices, fewer devices, different devices, or differently arranged devices than those shown in FIGS. 4A-4C. Furthermore, two or more devices shown in FIGS. 4A-4C may be implemented within a single device, or a single device shown in FIGS. 4A-4C may be implemented as multiple, distributed devices. Additionally, or alternatively, a set of devices (e.g., one or more devices) shown in FIGS. 4A-4C may perform one or more functions described as being performed by another set of devices shown in FIGS. 4A-4C.

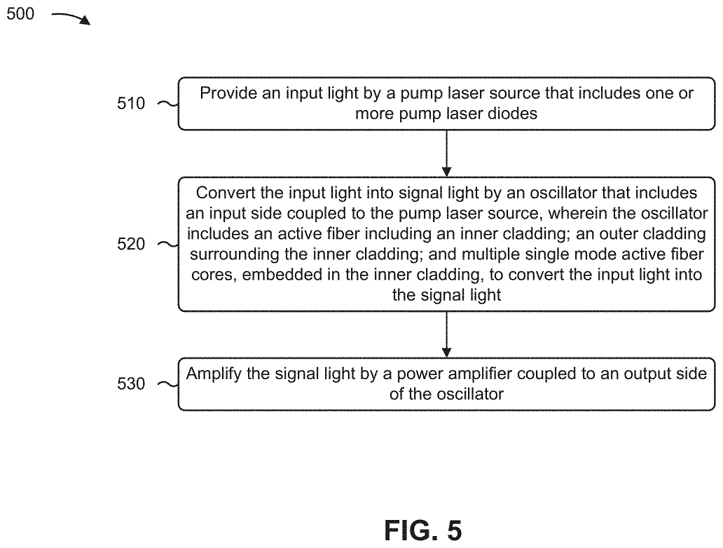

FIG. 5 is a flowchart of an example process 500 associated with operating a MOPA laser system that includes a multicore oscillator. In some implementations, one or more process blocks of FIG. 5 are performed by a MOPA laser system (e.g., MOPA laser architecture 200, 400, or the like). In some implementations, one or more process blocks of FIG. 5 are performed by another device or a group of devices separate from or included in the MOPA laser system, such as a pump laser source, a multicore oscillator, and/or a power amplifier.

As shown in FIG. 5, process 500 may include providing an input light by a pump laser source that includes one or more pump laser diodes (block 510). For example, one or more diodes 205, 405, a combiner 215, 415, and one or more output fibers coupling the diodes 205/405 and the combiner 215/415 may be included in a pump laser source 210, 410 configured to provide an input light, as described above.

As further shown in FIG. 5, process 500 may include converting the input light into signal light by an oscillator that includes an input side coupled to the pump laser source, wherein the oscillator includes an active fiber including an inner cladding, an outer cladding surrounding the inner cladding, and multiple single mode active fiber cores, embedded in the inner cladding, to convert the input light into the signal light (block 520). For example, the input light may be converted into signal light by an oscillator 225, 425 that includes an input side coupled to the pump laser source 210, 410, wherein the oscillator includes an inner cladding 320 or 460, an outer cladding 330 or 465 surrounding the inner cladding 320 or 460, and multiple single mode active fiber cores 310 or 455, embedded in the inner cladding 320 or 460, to convert the input light into the signal light, as described above.

As further shown in FIG. 5, process 500 may include amplifying the signal light by a power amplifier coupled to an output side of the oscillator (block 530). For example, the signal light may be amplified by a power amplifier 245 or 445 coupled to an output side of the oscillator 225 or 425, as described above.

Process 500 may include additional implementations, such as any single implementation or any combination of implementations described below and/or in connection with one or more other processes described elsewhere herein.

In a first implementation, the multiple single mode active fiber cores are associated with one or more of a uniform separation, a uniform core size, or a uniform doping.

In a second implementation, alone or in combination with the first implementation, the multiple single mode active fiber cores are associated with one or more of different separations, different core sizes, or different dopings.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A multicore oscillator, comprising:
an active fiber that includes:
an inner cladding;
an outer cladding surrounding the inner cladding; and
multiple single mode active fiber cores, embedded in the inner cladding, to convert pump light into signal light;
multiple first fiber Bragg gratings (FBGs) that are each configured to operate as a high reflector (HR) on an input side of each of the active fiber cores; and
multiple second FBGs that are each configured to operate as an output coupler (OC) on an output side of each of the active fiber cores.

2. The multicore oscillator of claim 1, wherein the first FBGs and the second FBGs are directly written into each of the multiple single mode active fiber cores.

3. The multicore oscillator of claim 1, wherein the multiple first FBGs are included in each core of a first passive fiber spliced to the input side of the active fiber cores and the multiple second FBGs are included in each core of a second passive fiber spliced to the output side of the active fiber cores.

4. The multicore oscillator of claim 1, wherein the multiple first FBGs and the multiple second FBGs are fabricated for different wavelengths.

5. The multicore oscillator of claim 1, wherein the multiple single mode active fiber cores are separated from one another within the inner cladding to satisfy a threshold level of crosstalk.

6. The multicore oscillator of claim 1, wherein the multiple single mode active fiber cores are associated with one or more of a uniform separation, a uniform core size, or a uniform doping.

7. The multicore oscillator of claim 1, wherein the multiple single mode active fiber cores are associated with one or more of different separations, different core sizes, or different dopings.

8. A master oscillator power amplifier (MOPA) system, comprising:
one or more pump laser sources;
a power amplifier; and
an oscillator including an input side coupled to the one or more pump laser sources and an output side coupled to the power amplifier, wherein the oscillator includes:
an active fiber including:
an inner cladding;
an outer cladding surrounding the inner cladding; and
multiple active fiber cores, embedded in the inner cladding, to convert pump light into signal light;
multiple first reflectors associated with each of the active fiber cores that are each configured to operate as a high reflector (HR) on the input side of the oscillator; and
multiple second reflectors associated with each of the active fiber cores that are each configured to operate as an output coupler (OC) on the output side of the oscillator.

9. The MOPA system of claim 8, wherein the output side of the oscillator is spliced to a passive large core bridge fiber that couples the oscillator and the power amplifier.

10. The MOPA system of claim 8, wherein the output side of the oscillator is spliced directly to the power amplifier.

11. The MOPA system of claim 8, wherein the power amplifier includes a single large core having a dimension that fully encircles the multiple active fiber cores.

12. The MOPA system of claim 8, wherein the power amplifier includes multiple concentric cores that are matched to the multiple active fiber cores.

13. The MOPA system of claim 8, wherein the power amplifier includes multiple offset cores that are matched to the multiple active fiber cores.

14. The MOPA system of claim 8, wherein the first reflectors and the second reflectors are directly written into the multiple active fiber cores.

15. The MOPA system of claim 8, wherein the multiple first reflectors are included in a first passive fiber spliced to the input side of the oscillator and the multiple second reflectors are included in a second passive fiber spliced between the power amplifier and the output side of the oscillator.

16. The MOPA system of claim 8, wherein the multiple first reflectors and the multiple second reflectors are tuned to different wavelengths.

17. The MOPA system of claim 8, wherein the multiple active fiber cores are separated from one another within the inner cladding to satisfy a threshold level of crosstalk.

18. A method, comprising:
providing an input light by a pump laser source that includes one or more pump laser diodes;
converting the input light into signal light by an oscillator that includes an input side coupled to the pump laser source, wherein the oscillator includes:
an active fiber including:
an inner cladding;
an outer cladding surrounding the inner cladding; and
multiple single mode active fiber cores, embedded in the inner cladding, to convert the input light into the signal light; and
amplifying the signal light by a power amplifier coupled to an output side of the oscillator.

19. The method of claim 18, wherein the multiple single mode active fiber cores are associated with one or more of a uniform separation, a uniform core size, or a uniform doping.

20. The method of claim 18, wherein the multiple single mode active fiber cores are associated with one or more of different separations, different core sizes, or different doping.
